(19) United States
(12) Patent Application Publication
(10) Pub. No.: US 2025/0339950 A1
(43) Pub. Date: Nov. 6, 2025

(54) TOOL HOLDING SYSTEM

(71) Applicants: Guy Clifford Clapp, Stephenville, TX (US); Clifford W. Clapp, Weatherford, TX (US)

(72) Inventors: Guy Clifford Clapp, Stephenville, TX (US); Clifford W. Clapp, Weatherford, TX (US)

(21) Appl. No.: 19/269,308

(22) Filed: Jul. 15, 2025

Related U.S. Application Data
(63) Continuation-in-part of application No. 18/423,230, filed on Jan. 25, 2024.
(63) Continuation-in-part of application No. 18/956,982, filed on Nov. 22, 2024.
Application No. 18/956,982 is a continuation-in-part of application No. 17/336,727, filed on Jun. 2, 2021, now Pat. No. 11,931,882.

(51) Int. Cl. B25H 3/04; B25H 1/12; B25H 3/02

(52) U.S. Cl. CPC B25H 3/04; B25H 1/12; B25H 3/022

(57) ABSTRACT

A tool holding mechanism includes a plate configured with slots defined by forward projecting segments defining slots therebetween with an opening that may be narrowed. One or more of the slot-defining segments may include a bendable tab, typically comprising a partially cut-out portion of the segment, that may be bent into the space of the slot to narrow the slot and thereby restrict egress from the slot by partially blocking the longitudinal and/or transverse aperture of the slot. Preferably, the plate is sufficiently pliable for a user to readily bend the tabs manually to selectively customize the slots for specific tools.

### CROSS-REFERENCE TO RELATED APPLICATIONS

This application is a continuation-in-part of U.S. patent application Ser. No. 18/423,230, filed on Jan. 25, 2024, which is a continuation-in-part of U.S. patent application Ser. No. 17/336,727, filed on Jun. 2, 2021, and is a continuation-in-part of Ser. No. 18/596,982, filed on Mar. 6, 2024, which is a continuation-in-part of U.S. patent application Ser. No. 17/336,727, filed on Jun. 2, 2021. Each of these applications is hereby incorporated by reference.

### BACKGROUND AND SUMMARY

This invention pertains generally to tool holding mechanisms and systems.

Tool boxes are used in a variety of configurations and purposes. Some tool boxes are configured for maximum storage in a compact container. Other tool boxes are configured to store higher quantities of tools.

Storage mechanisms may be configured to be easily accessible for tools that are used often. However, easily accessible storage mechanisms lack security and significant restraining features that prevent tools from being stolen or becoming loose floating items in a tool enclosure.

Accordingly, there is a need for tool holding mechanisms and systems to efficiently store and securely engage tools for ease of access and transport.

In an aspect of the invention, a tool holder includes a slotted plate of a malleable material with bendable tabs positioned on plate portions defining the slots such that the tabs may be bent into the voids of the slots to restrict egress from the slot. The plate has segments projecting to one edge of the slot (the “front”) separated by the slots. On one or more of these segments, a bendable tab is connected to a segment at the edge of a slot such that the tab may be bent into a position to reduce an aperture of the slot. For example, for tool holder that is positioned roughly horizontally, a slot will form an opening through the plate from the top to the bottom and it will form an opening on the front edge of the plate. The tab may be bent to reduce the size of the top-bottom opening to restrain tools from entirely passing through the opening. And the tab may be bent to reduce the size of the opening to the front edge of the plate to restrain tools from exiting through the front opening.

In an another aspect of the invention, a tool holding mechanism may include two slotted plate-like segments extending out from a spanning plate-like segment. In use, the mechanism is oriented so that one of the slotted segments (the top segment) is positioned above the other segment (the bottom segment). The top segment may extend out from the spanning segment (the back segment) at an angle greater than 90 degrees, so that the top segment is angled up: the point at which the top segment is attached to the back segment (the proximal edge of the top segment) is positioned below the distal edge of the top segment. Top segment slots are open to the distal edge of the top segment. The bottom segment may extend out from the spanning segment at an angle of about 90 degrees (90 degrees±20 degrees). Bottom segment slots are open to the distal edge of the bottom segment. The top and bottom slots are aligned such that a portion of an elongate tool (e.g., the beam of a wrench or the shank of a screwdriver) can be positioned in both slots at once. An upward slope of the top segment serves to engage a feature of the tool that is wider than the slot (e.g., the open end of a wrench or the handle of a screwdriver). To remove the tool from the mechanism, the tool must first be moved up so that the wide portion of the tool is above the slot opening on the top segment. Thus, the upward slope of the top segment helps restrain the tool from inadvertent escape from the tool holder.

The tool holding mechanism may include a magnet positioned between the top and bottom segments such that the magnet will engage a portion of an elongate tool positioned in both slots at once. For example, the magnet may engage the beam of a slot-mounted wrench to further restrain the wrench against inadvertent escape from the tool holder.

The tool holding mechanism may include hooks positioned on the left and right sides of the holder (e.g., one connected to the left side of the back segment and another connected to the right side of the back segment, each hook positioned between the top and bottom segments). These are band-retention hooks in that they are configured to retain an tool-retaining band (e.g., an elastic band, metal strip, or coiled spring). In use, a retaining band may be positioned on the hooks such that the band is positioned on the side of any tool(s) positioned in the holder slot(s) that is away from the back segment and the band is strained to span the distance between the hooks, thereby generating a force pushing the tools toward the back segment. Thus, the band further restrains the tool(s) from inadvertent escape from the tool holder.

### BRIEF DESCRIPTION OF THE DRAWINGS

These and other features, aspects, and advantages of the present invention will become better understood with reference to the following description, appended claims, and accompanying drawings where:

FIG. 1 is a front perspective view of a tool box according to an aspect of the invention.

FIGS. 2A-2E are various views of configurations of a first tool holding mechanism according to aspects of the invention.

FIG. 3 is a front perspective view of a second tool holding mechanism according to an aspect of the invention.

FIG. 4 is a front perspective view of a third tool holding mechanism according to an aspect of the invention.

FIG. 5 is a front perspective view of a fourth tool holding mechanism according to an aspect of the invention.

FIGS. 6A-6B are views of an exemplary door stop mechanism according to an aspect of the invention.

FIG. 7 is a front perspective of a hinge.

FIGS. 8A-8B are views of a hinge locking system according to an aspect of the invention.

FIG. 9 is a perspective view of a portable tool holding system according to an aspect of the invention.

FIGS. 10A-10C are various views of an exemplary first tool holding mechanism according to an aspect of the invention.

FIGS. 11-14 depict exemplary configurations of an elastic-band-retention hook according to an aspect of the invention.

FIGS. 15A-15D are perspective views of an exemplary fifth tool holding mechanism according to an aspect of the invention.

FIGS. 16A-16B are perspective and side views of an exemplary sixth tool holding mechanism according to an aspect of the invention.

FIGS. 17A-17F are various views of an exemplary seventh tool holding mechanism according to an aspect of the invention.

FIGS. 18A-18B are various views of an exemplary tool holder with bendable slot-restricting tabs, according to an aspect of the invention.

FIG. 19 is a perspective view of an exemplary tool holder incorporating a variety of features according to aspects of the invention.

FIG. 20 is a perspective view of an exemplary tool holder incorporating a variety of slot-narrowing tool-retention lips according to aspects of the invention.

### DETAILED DESCRIPTION

In the summary above, and in the description below, reference is made to particular features of the invention in the context of exemplary embodiments of the invention. The features are described in the context of the exemplary embodiments to facilitate understanding. But the invention is not limited to the exemplary embodiments. And the features are not limited to the embodiments by which they are described. The invention provides a number of inventive features which can be combined in many ways, and the invention can be embodied in a wide variety of contexts. Unless expressly set forth as an essential feature of the invention, a feature of a particular embodiment should not be read into the claims unless expressly recited in a claim.

Except as explicitly defined otherwise, the words and phrases used herein, including terms used in the claims, carry the same meaning they carry to one of ordinary skill in the art as ordinarily used in the art. The terms “first,” “second,” and the like may be used to distinguish one element from another without denoting any order or importance.

Because one of ordinary skill in the art may best understand the structure of the invention by the relationship of various structural features of the invention to the environment in which the invention is intended to function or a workpiece with which the invention is intended to function, certain structural features may be explained or claimed with reference to the environment or workpiece. Unless used in the context of claiming a particular aspect of the environment or workpiece, reference to the environment or workpiece refers to aspects of the structural feature, not to an instance of the environment or workpiece.

Because one of ordinary skill in the art may best understand the structure of the invention by the function of various structural features of the invention, certain structural features may be explained or claimed with reference to the function of a feature. Unless used in the context of describing or claiming a particular inventive function (e.g., a process), reference to the function of a structural feature refers to the capability of the structural feature, not to an instance of use of the invention.

Except for claims that include language introducing a function with “means for” or “step for,” the claims are not recited in so-called means-plus-function or step-plus-function format governed by 35 U.S.C. § 112(f). Claims that include the “means for [function]” language but also recite the structure for performing the function are not means-plus-function claims governed by § 112(f). Claims that include the “step for [function]” language but also recite an act for performing the function are not step-plus-function claims governed by § 112(f).

Except as otherwise stated herein or as is otherwise clear from context, the inventive methods comprising or consisting of more than one step may be carried out without concern for the order of the steps.

The terms “comprising,” “comprises,” “including,” “includes,” “having,” “haves,” and their grammatical equivalents are used herein to mean that other components or steps are optionally present. For example, an article comprising A, B, and C includes an article having only A, B, and C as well as articles having A, B, C, and other components. And a method comprising the steps A, B, and C includes methods having only the steps A, B, and C as well as methods having the steps A, B, C, and other steps.

Terms of degree, such as “substantially,” “about,” and “roughly” are used herein to denote features that satisfy their technological purpose equivalently to a feature that is “exact.” For example, a component A is “substantially” perpendicular to a second component B if A and B are at an angle such as to equivalently satisfy the technological purpose of A being perpendicular to B.

Except as otherwise stated herein, or as is otherwise clear from context, the term “or” is used herein in its inclusive sense. For example, “A or B” means “A or B, or both A and B.”

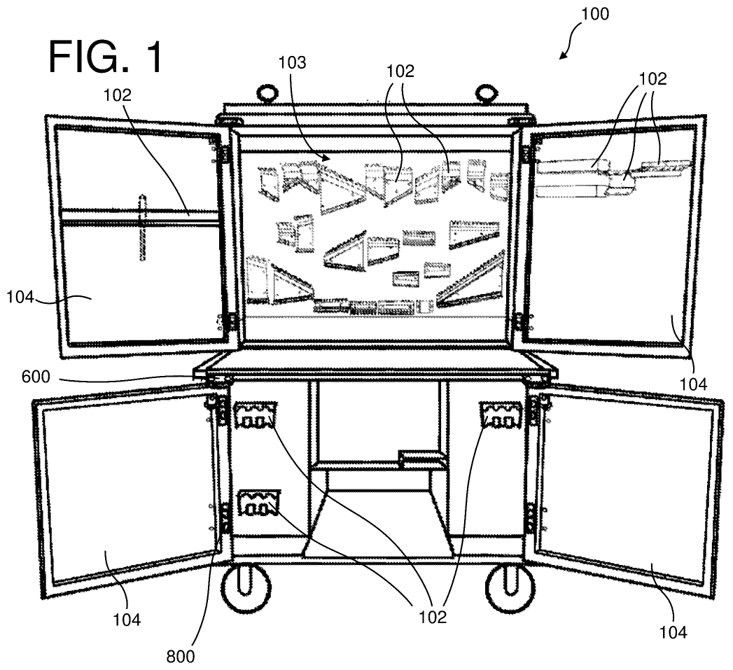

FIG. 1 depicts a front perspective of an exemplary tool box 100 according to an aspect of the invention. The tool box 100 may include a variety of tool holding mechanisms 102, at least one door 104, at least one door stop mechanism 600, and at least one hinge locking system 800.

In one embodiment, the tool box 100 may comprise multiple tiers, each tier comprising storage capacity for tool holding mechanisms. One of ordinary skill in the art will appreciate that the tool box 100 may comprise a variety of combinations and quantities of different tool holding mechanisms.

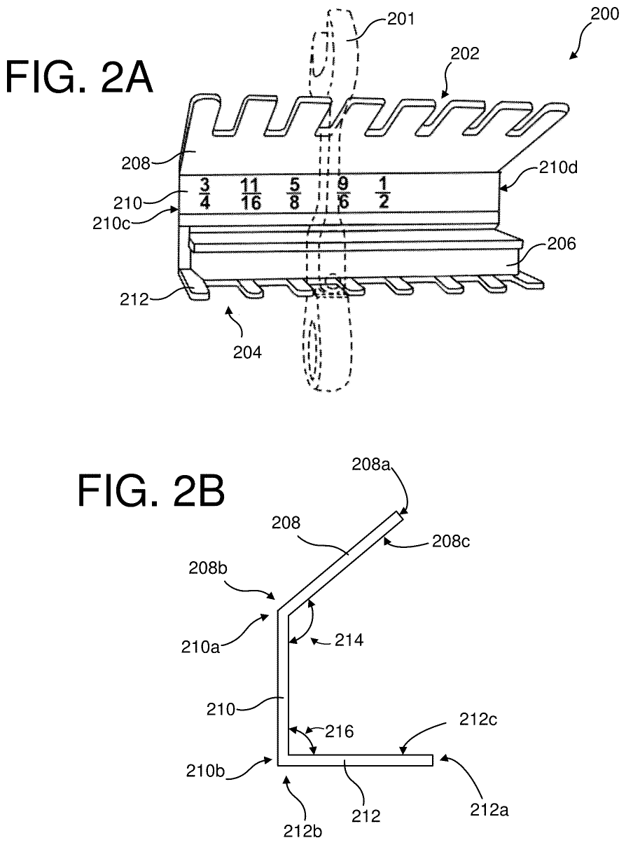

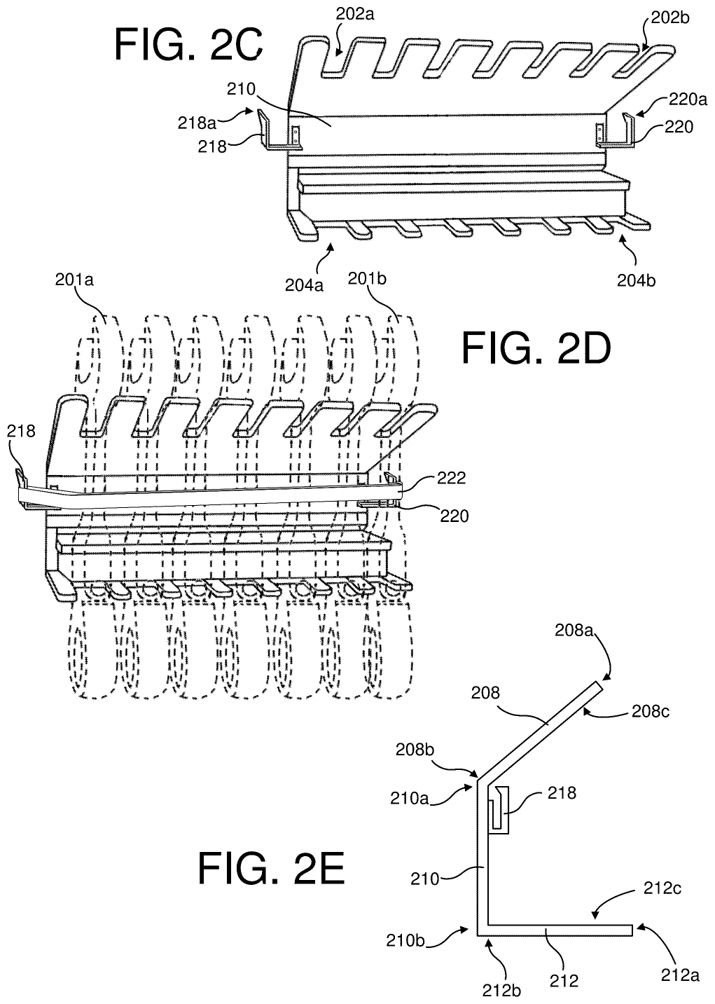

FIGS. 2A-2B are front perspective and left-side views, respectively, of an exemplary first tool holding mechanism 200. (For sake of clarity, FIG. 2B omits certain features depicted in FIG. 2A.) In one embodiment, the first tool holding mechanism 200 may comprise a first cavity 202, a second cavity 204, and a magnetic strip 206 interposed between the first cavity 202 and the second cavity 204. The magnetic strip 206 may be disposed in a configuration that allows a tool 201 that is placed in the first cavity 202 and the second cavity 204 to magnetically couple to the magnetic strip 206.

The first cavity 202 may comprise a width that allows a first portion of a tool 201 to pass into the first cavity 202. The second cavity 204 may comprise a width that allows a second portion of the tool to pass into the second cavity 204. In one embodiment, the width of the first cavity 202 may be substantially the same as the width of the second cavity 204. In another embodiment, the width of the first cavity 202 may be different than the width of the second cavity 204. One of ordinary skill in the art will appreciate that different widths are realized for different tools. The first tool holding mechanism 200 may be configured to receive a custom set of tools. One of ordinary skill in the art will also appreciate that the first tool holding mechanism 200 may be configured to comprise a plurality of same or different first cavities 202 and second cavities 204.

In one embodiment, the magnetic strip 206 may be disposed closer to the second cavity 204 than to the first cavity 202. One of ordinary skill in the art will appreciate that the magnetic strip 206 may be interposed at any location between the first cavity 202 and the second cavity 204.

In one embodiment, the first tool holding mechanism 200 may comprise a single piece of material, such as, but not limited to, aluminum. The single piece of material may be bent at two locations to form an upper segment 208 and a lower segment 212. In one embodiment, the bends may be configured to create angles that are at least substantially equal to, or greater than, ninety-degrees. In one embodiment, the upper segment 208 may include the first cavity 202 (an upper slot) and the lower segment 212 may include the second cavity 204 (a lower slot).

The first tool holding mechanism 200 may be coupled to a surface of the tool box 100. In one embodiment, the surface may be an internal surface of the tool box 100. In one embodiment, the surface may an internal surface of the door of the tool box 100.

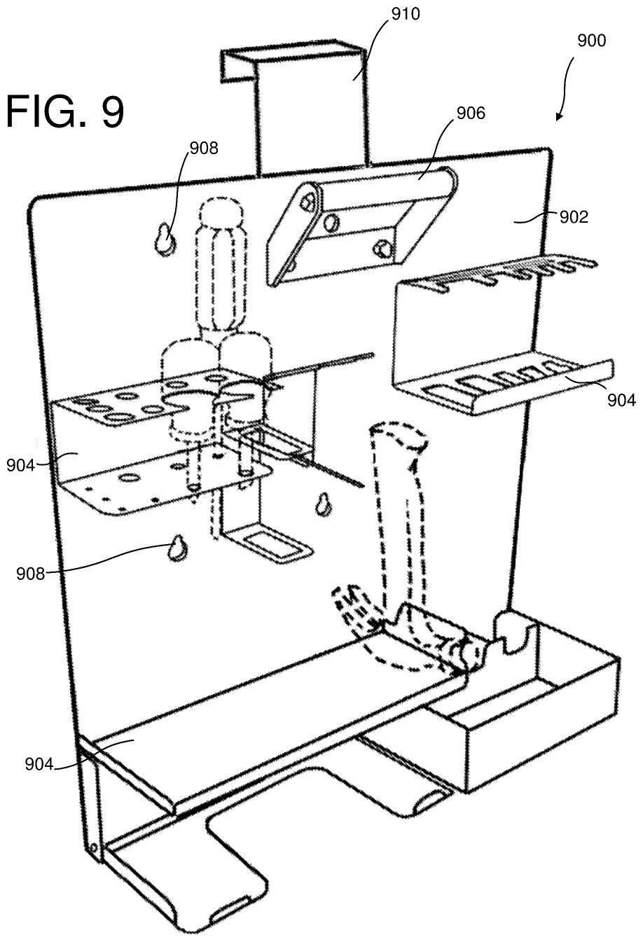

In one embodiment, the first tool holding mechanism 200 may be coupled to a surface of a mountable plate, such as the mountable plate 902 of FIG. 9.

In an exemplary embodiment, the first tool holding mechanism 200 may comprise: (1) a back segment 210 having a top side 210a, a bottom side 210b, a left side 210c, and a right side 210d, (2) a top segment 208 having a front side 208a, a back side 208b, a face 208c, and an upper slot 202 and configured to project out from the back segment 210 with a facing angle 214 of greater than 90 degrees, and (3) a bottom segment 212 having a front side 212a, a back side 212b, a face 212c, and a lower slot 204 and configured to project out from the back 210 with a facing angle 215 of about 90 degrees (i.e., 90 degrees±20 degrees). The “face” 208c of the top surface 208 is that side oriented toward the bottom surface 212. The “face” 212c of the bottom surface 212 is that side oriented toward the top surface 208. The “facing angle” 214, 216 is the angle between the top or bottom segment 208, 212 and the back surface 210 on the side of the surface's face 208c, 212c.

FIGS. 2C-2E are front perspective (FIGS. 2C-2D) and left-side (FIG. 2E) views of the exemplary first tool holding mechanism 200 configured with band-retention hooks 218, 220 to secure tools in the mechanism 200 using an elastic band 222. (For sake of clarity, FIG. 2E omits certain features depicted in FIGS. 2C-2D.) One or more band-retention hooks 218, 220 are affixed or integral to the back 210 of the tool holding mechanism 200 toward the left 210c and/or right 210d of the back 210. (The band-retention hooks may be affixed or integral to a segment other than the back segment.) The hooks 218, 220 are configured to receive and retain an elastic band to the left and right of the left-most 201a and right-most 201b tools in the tool holding mechanism 200 when the mechanism 200 is loaded with tools. In a preferred embodiment, a left hook 218 is positioned on the back segment 210 such that a band-securing feature 218a of the hook 218 is positioned to the left of the left-most tool slots 202a, 204a and a right hook 220 is positioned on the back 210 such that a band-securing feature 220a of the hook 220 projects to the right of the right-most tool slots 202b, 204b. The band 222 is configured to engage the hooks 218, 220 under tension when the mechanism 200 is loaded with tools; this tension provides a force on the tools 201 toward the back segment 210 of the mechanism, thereby holding the tools 201 in place in the slots 202, 204. (In a single-tool embodiment, having only a single upper slot 202 and a single lower slot 204, the left-most and right-most slots (or tools) are the same slot (or tool).) The tool-retaining force provided by the band 222 engaging the hooks 218, 220 serves to hold the tools in place, e.g., during transport. The band 222 may be variously configured to provide various retaining forces depending on the application. For example, the force may be increased for heavier tools or harsher transport conditions by shortening or thickening or stiffening the band 222. The length and/or thickness of the band can be identified by the color of the band. Multiple bands may also be employed, using the same or different band-retention hooks. For example, a mechanism may be configured with two pairs of band-retention hooks, each pair designated for a distinct band. In another example, a mechanism may be configured with one pair of band-retention hooks wherein each hook is of sufficient dimension to receive multiple bands.

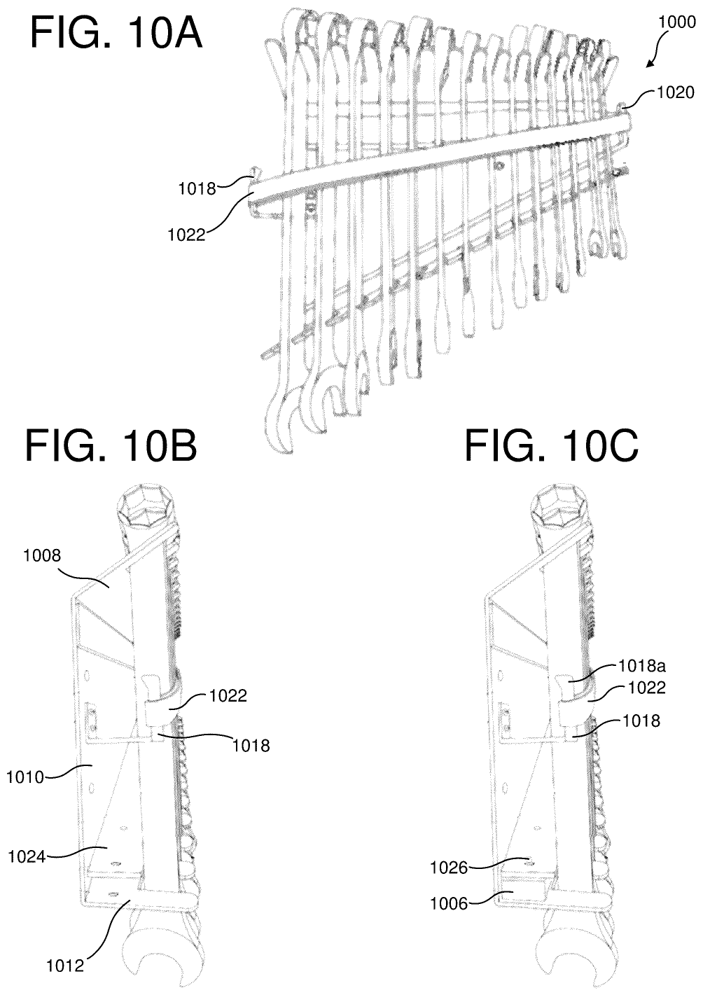

FIGS. 10A-10C depict another exemplary tool holding mechanism 1000 configured with band-retention hooks 1018, 1020 to secure tools in the mechanism 1000 using an elastic band 1022. FIG. 10A is a front perspective view, FIGS. 10B-10C are side perspective views. As with the exemplary embodiment described with reference to FIGS. 2A-2E, the tool holding mechanism 1000 in FIGS. 10A-10C includes a slotted upper segment 1008 projecting out from a back segment 1010 at an obtuse facing angle and a slotted lower segment 1012 projecting out from the back segment 1010 at about a 90-degree facing angle. One or more band-retention hooks 1018, 1020 project from the back 1010 and are configured to receive and retain a rubber band 1022 that may be placed relative to the tools and retention hooks 1018, 1020 so as to provide a force on the tools directed to the back 1010 and thereby retain the tools in the slots of the upper and lower segments 1008, 1012. The mechanism 1000 may include a magnet 1006 positioned between the upper and lower segments 1008, 1012 and which my placed between the lower segment 1012 and a magnet brace 1024 and secured in place with one or more removable pins 1026 positioned through holes in the brace 1024, magnet 1026, and lower segment 1012. The pins 1026 and holes may be smooth (e.g., dowel or spring pin) or threaded (e.g., screw or bolt). The magnet may be secured to the bottom segment 1012 via removable pins 1026 such the inserting or removing the pins may be accomplished from the underside of the lower segment 1012 so as to not require removal of tools. The exemplary mechanism 1000 depicted in FIGS. 10A-10C is configured for use with tools of varying lengths in that the distance between the upper and lower segments 1008, 1012, and thus the distance between upper and lower slots in those segments, varies.

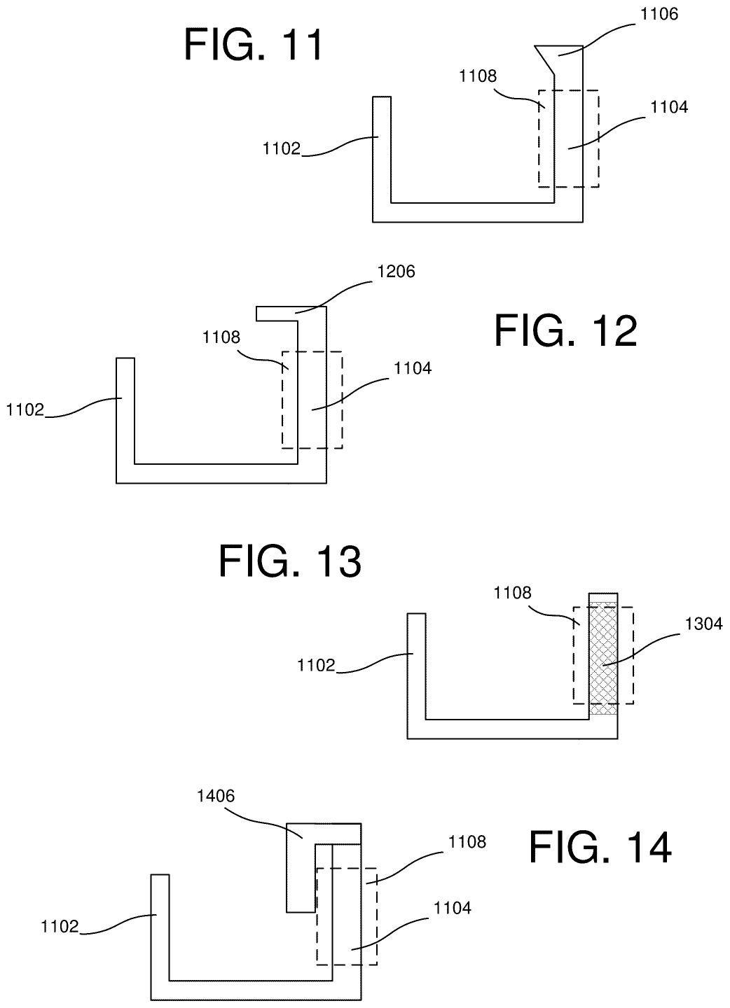

The band-retention hooks described above may be configured with any of a variety of mechanisms to help prevent the band from inadvertently disengaging from or slipping off the hook. For example, as depicted in FIG. 11, the portion 1104 of the hook configured to engage the band 1108 (distinct from the portion 1102 configured to mount to the tool holding mechanism) may have a flared end 1106 such as to resist removal of the band by requiring excess stretching of the band as compared to engagement portion 1104. In another example, as depicted in FIG. 12, the portion 1104 of the hook configured to engage the band may have a protruding end 1206 such as to resist removal of the band by requiring excess stretching of the band as compared to engagement portion 1104. In another example, as depicted in FIG. 13, the portion 1304 of the hook configured to engage the band may be imbued with a friction-enhancing surface (shown in cross hatch), such as a knurled, dimpled, or roughened surface. In another example, as depicted in FIG. 14, a clip 1406 may be used to secure the band 1108 to the portion 1104 of the hook configured to engage the band. The clip may be configured to removably attach to the clip or may be pivotably attached to the band-engagement portion 1104.

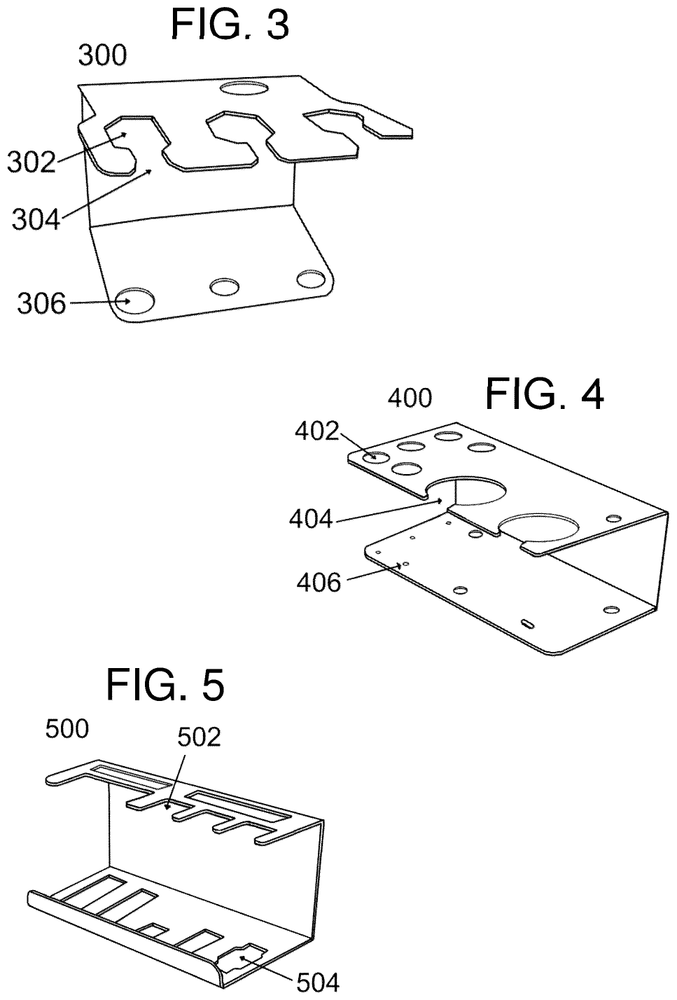

FIG. 3 depicts a front perspective of a second tool holding mechanism 300. In one embodiment, the second tool holding mechanism 300 may comprise an upper cavity and a lower cavity 306. The upper cavity may comprise a first portion 302 and a second portion 304. The first portion 302 of the upper cavity may comprise a width greater than a width of the second portion 304 of the upper cavity. The first portion 302 may be internal to the second portion 304 so that the second portion 304 may form a channel to the first portion 302. The width of the first portion 302 of the upper cavity may be smaller than a first width of a tool. In one embodiment, the first width of the tool may be a width of a first portion of a handle of the tool. The width of the first portion 302 of the upper cavity and the width of the second portion 304 of the upper cavity may be greater than a second width of the tool. In one embodiment, the second width of the tool may be a width of a second portion of the handle of the tool. In one embodiment, a user may pass the second portion of the handle through the second portion 304 of the upper cavity and then set the first portion of the tool into the first portion 302 of the upper cavity. The lower cavity 306 may comprise a width greater than a width of an operational portion of the tool. In one embodiment, in response to the user setting the first portion of the handle of the tool into the first portion 302 of the upper cavity, the operational portion of the tool may set into the lower cavity 306. The second tool holding mechanism 300 may be coupled to a surface of the tool box 100. In one embodiment, the surface may be an internal surface of the tool box 100. In one embodiment, the surface may an internal surface of the door of the tool box 100. In one embodiment, the second tool holding mechanism 300 may be coupled to a surface of a mountable plate, such as the mountable plate 902 of FIG. 9.

FIG. 4 depicts a front perspective of a third tool holding mechanism 400. The third tool holding mechanism 400 may comprise a first type of upper cavity 402, a second type of upper cavity 404, and a lower cavity 406. The second type of upper cavity 404 may be the upper cavity of FIG. 3. The first type of upper cavity 402 may be internal to an upper portion of the third tool holding mechanism 400. The second type of upper cavity 404 may be exposed to a space external to the upper portion of the third tool holding mechanism 400 such that a tool may laterally pass into the second type of upper cavity 404. One of ordinary skill in the art will appreciate that a variety of types and quantities of cavities may be configured into the third tool holding mechanism. One of ordinary skill in the art will also appreciate that the configuration may be relative to a set of tools. The third tool holding mechanism 400 may be coupled to a surface of the tool box 100. In one embodiment, the surface may be an internal surface of the tool box 100. In one embodiment, the surface may an internal surface of the door of the tool box 100. In one embodiment, the third tool holding mechanism 400 may be coupled to a surface of a mountable plate, such as the mountable plate 902 of FIG. 9.

FIG. 5 depicts a front perspective of a fourth tool holding mechanism 500. The fourth tool holding mechanism 500 may comprise an upper cavity 502 and a lower cavity 504. The upper cavity 502 may be exposed to a space external to an upper portion of the fourth tool holding mechanism 500 such that a tool may laterally pass into the upper cavity 502. The lower cavity 504 may be internal to a lower portion of the fourth tool holding mechanism 500. The fourth tool holding mechanism 500 may be coupled to a surface of the tool box 100. In one embodiment, the surface may be an internal surface of the tool box 100. In one embodiment, the surface may an internal surface of the door of the tool box 100. In one embodiment, the fourth tool holding mechanism 500 may be coupled to a surface of a mountable plate, such as the mountable plate 902 of FIG. 9.

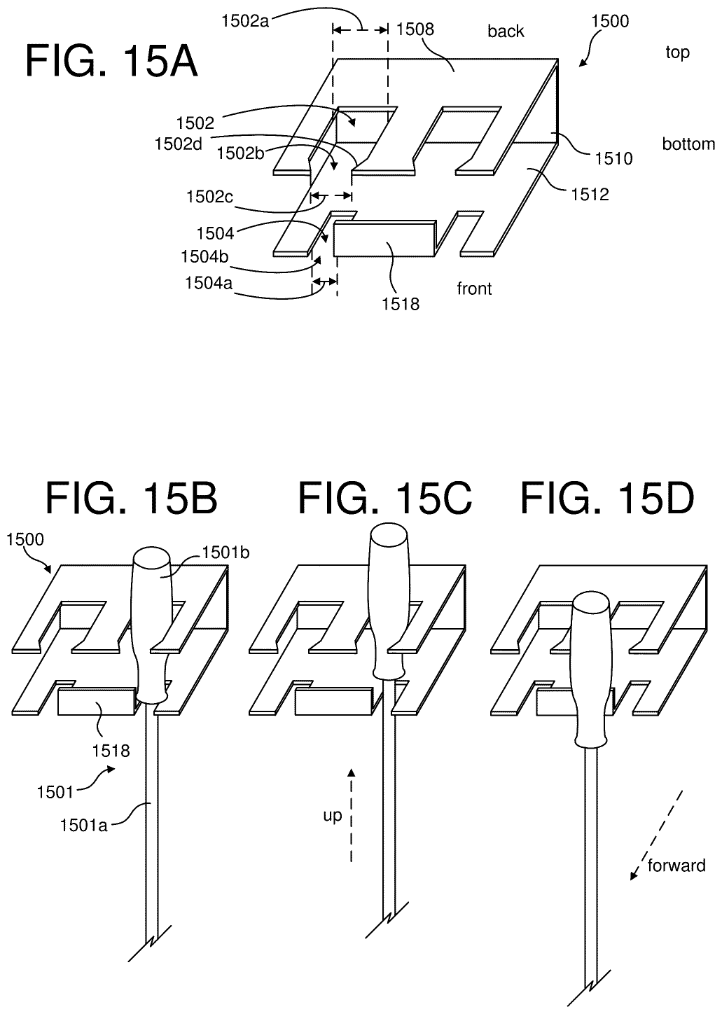

FIGS. 15A-15D are perspective views depicting a fifth tool holding mechanism 1500. In this exemplary embodiment, the fifth tool holding mechanism 1500 may comprise: (1) a back segment 1510 (2) a top segment 1508, and (3) a bottom segment 1512. The top 1508 and bottom 1512 segments connect to and project out from the back segment 1510. The top segment includes one or more top slots 1502 opening to the front of the top segment 1508. The bottom segment 1512 includes one or more bottom slots 1504 opening to the front of the bottom segment 1512. The top 1502 and bottom 1504 slots are aligned such that the slots 1502, 1504 may simultaneously receive an elongate handled tool 1501 (e.g., screw driver or pry bar) as shown in FIGS. 15B and 15C. The top slot 1502 has a width 1502a. The bottom slot 1504 has a width 1504a that is narrower than the top slot's width 1502a. Due to this difference in widths, the slots may be configured so that: (1) both the bottom and top slots are wide enough to receive a shank/shaft 1501a of the tool 1501, (2) the top slot 1502 is wide enough to receive the handle 1501b of the tool 1501, and (3) the bottom slot 1504 is too narrow to receive the handle 1501b. Thus, as depicted in FIG. 15B, the tool holding mechanism 1500 is configured to hold the tool 1501 with the shank/shaft 1501a projecting down through the bottom slot 1504 and the handle 1501b projecting up through the top slot 1502; the handle 1501b does not project through the bottom slot 1504 and is instead supported by the bottom segment 1512. A front retaining segment 1518 is positioned at the front of the bottom segment 1512 adjacent to the bottom slot 1504 near the front opening 1504b of the bottom slot 1504 and projects up from the bottom segment 1512 toward the top segment 1508. The front retaining segment 1518 defines a front aperture narrower than the tool handle 1501b and thereby restrains the tool 1501 from sliding out of the bottom slot 1504 to the front. As depicted in FIGS. 15B-15D, the tool 1501 would have to be moved up (FIG. 15C) from the bottom segment 1512 in an amount greater than the distance the front retaining segment 1518 projects up toward the top segment 1508 before it can slide forward (FIG. 15D) out of the bottom slot 1504. (The dashed arrows in FIGS. 15C and 15D denote the up and forward movement of the tool 1501 to extract the tool from the tool holding mechanism 1500.) The front opening 1502b of the top slot 1502 may be narrowed by a retaining protuberance (a “lip”) 1502d such the width 1502c of the top slot's front opening 1502b is narrower than the widest portion of the tool handle 1501b. The retaining lip 1502d thereby restrains the tool 1501 from sliding out of the top slot 1502 to the front in much the same way the front retaining segment 1518 restrains the tool 1501 from sliding out of the bottom slot 1504 to the front. For tool handles 1501b with a taper (as depicted, e.g., in FIGS. 15B-15D), the top slot's front opening 1502b may have a width 1502c greater than the width of a narrowed portion of the tool handle 1501b. In such a configuration of the tool holder 1500, removing the tool 1501 from the holder 1500 requires moving the tool up so that the handle is above the front retaining segment 1518 and the narrowed portion of the handle is at the level of the of the top slot's front opening 1502b. For tool handles of a consistent width, removing the tool 1501 from the holder 1500 requires moving the tool up so that the handle is above the top segment 1508. In either circumstance, the upward movement of the tool 1501 required to remove the tool will be no greater than the length of the handle 1501b.

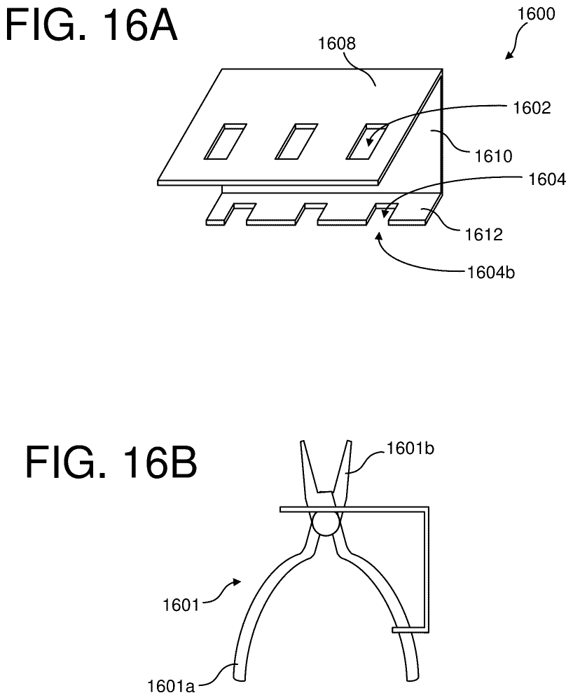

FIGS. 16A-16B are perspective and side views, respectively, depicting a sixth tool holding mechanism 1600. In this exemplary embodiment, the sixth tool holding mechanism 1600 may comprise: (1) a back segment 1610 (2) a top segment 1608, and (3) a bottom segment 1612. The top 1608 and bottom 1612 segments connect to and project out from the back segment 1610. The top segment 1608 includes a top hole 1602. The bottom segment 1612 includes one or more bottom slots 1604 opening 1604b to the front of the bottom segment 1612. The top holes 1602 and bottom slots 1604 are aligned such that the holes 1602 and slots 1604 may simultaneously receive biased-open pliers 1601. The top hole 1602 receives the jaws 1601b and the bottom slot 1604 receives a handle 1601a through the bottom slot's front opening 1604b. As the pliers 1601 are biased open, the open jaws 1601b are retained in the top hole 1602 and the handle 1601a is retained in the bottom slot 1604.

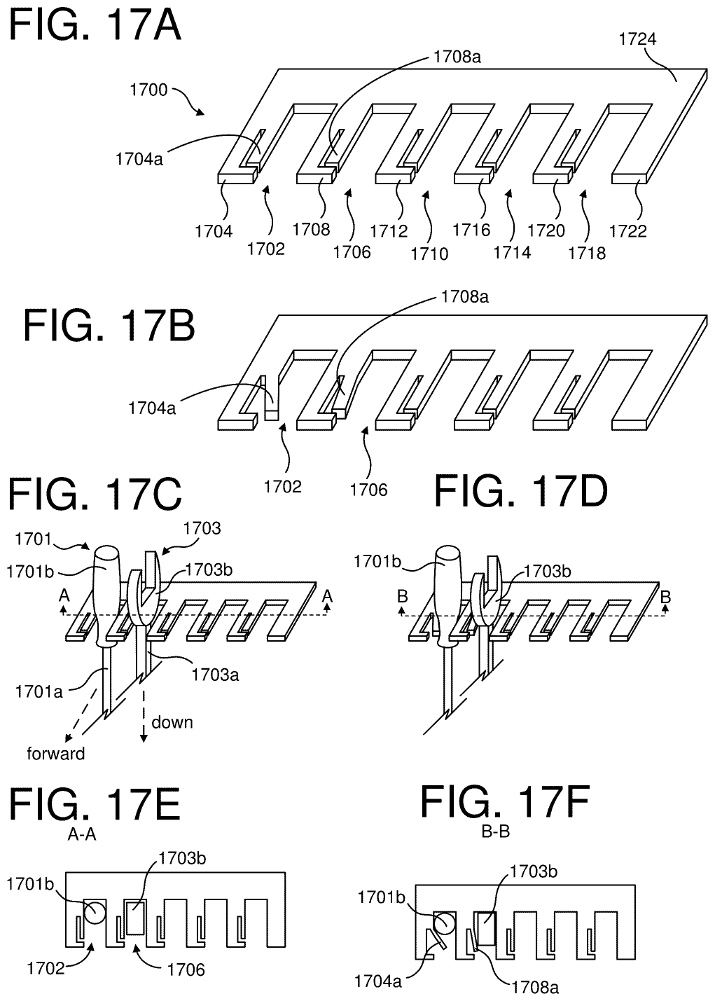

FIGS. 17A-17D are perspective views and FIGS. 17E-17F are sectional views depicting a seventh tool holding mechanism 1700. In this exemplary embodiment, the seventh tool holding mechanism 1700 may comprise a plate 1724 with one or more slots 1702, 1706, 1710, 1714, 1718 opening to one side of the plate 1724 (the “front” side). The slot walls are defined by segments 1704, 1708, 1712, 1716, 1720, 1722 of the plate 1724. Some (or all) of the slot-defining segments 1704, 1708, 1712, 1716, 1720, 1722 include bendable tabs 1704a, 1708a that may be bent or pivoted toward the opposite slot-defining segment to narrow the effective aperture of the slot 1702, 1706. This enables user customization of the tool holding mechanism 1700 for specific tools. In FIG. 17A, the bendable tabs 1704a, 1708a of two slots 1702, 1706 are depicted in a relaxed state. These tabs 1704a, 1708a may be constructed, e.g., by laser-cutting or jet-cutting a line in a plate 1724 at the one or more of the segments 1704, 1708, 1712 defining the slots 1702, 1706. The tabs 1704a, 1708a remain integral to the plate 1724 but the plate is of a malleable material (e.g., steel) and the tabs 1704a, 1708a are of a size that enable manual bending of the tab 1704a, 1708a by, e.g., pulling on the tab 1704a, 1708a with fingers or prying the tab 1704a, 1708a by twisting the blade of a flat-head screw driver inserted into the cut line defining the bendable tab 1704a, 1708a. In FIG. 17B, the bendable tabs 1704a, 1708a of two slots 1702, 1706 are depicted in a bent state. The first tab 1704a is bent a first degree to limit the aperture of the first slot 1702. The second tab 1708a is bent a second degree to limit the aperture of the second slot 1706. The first degree is not necessarily the same as the second degree. Thus, the first slot 1702 may be customized for a first tool and the second slot 1706 may be customized for a second tool having different characteristics than the first tool. Other bendable tabs in the tool holder 1700 may be bent to accommodate different tools. For example, a tool holder 1700 may be configured with a series of slots with bendable tabs and each tab bent to configure a slot for a particular wrench in a set of wrenches. FIGS. 17C and 17E depict two tools 1701, 1703 (e.g., a screw driver and a wrench) placed in the first two slots 1702, 1706 of a tool holder 1700 with tabs in the relaxed state. In this example, the first tool 1701 (e.g., a screw driver) has a handle 1701b that varies in girth along its length, narrower near the shaft 1701a. At some point distant from the shaft 1701a, the handle 1701b is wider than the slot 1702 in which it is inserted with the shaft down. Thus, the tool 1701 will not pass down through the slot 1702. But the tool 1701 is free to move forward out of the slot 1702. A tab 1704a may be bent to sufficiently restrict the forward aperture of the slot 1702 to prevent this forward escape, as depicted in FIGS. 17D and 17F. The second tool 1703 (e.g., a wrench) has a head 1703b with a girth larger than that of its shaft 1703a but its head 1703b is narrower than the width of the slot 1706 in which it is inserted. Thus, the tool 1703 is free to move down through the slot 1706 as well as forward out of the slot 1706. The slot 1706 does not hold the tool 1703 at all when its tab 1708a is in the relaxed state. A tab 1708a may be bent to sufficiently restrict the forward and vertical apertures of the slot 1706 to close the forward and downward escape paths, as depicted in FIGS. 17D and 17F. In this way, a tool holder with slots having bendable tabs configured to restrict the slots' aperture can be configured for a variety of tools.

The tool holder 1700 may be incorporated into other tool holding mechanisms to retain the tools. For example, the upper segment 208 in the tool holding mechanism 200 depicted in FIGS. 2A-2E may be configured as the tool holder 1700, with bendable tabs in some or all of the slots 202. This would further serve to secure the tools in place, in some cases enabling a facing angle 214 of 90 degrees or less while still having sufficient tool-retention utility for a particular application. The other tool holding mechanisms described herein may be similarly modified to include the tool holder 1700 to add customizable tool-retention utility to those holders.

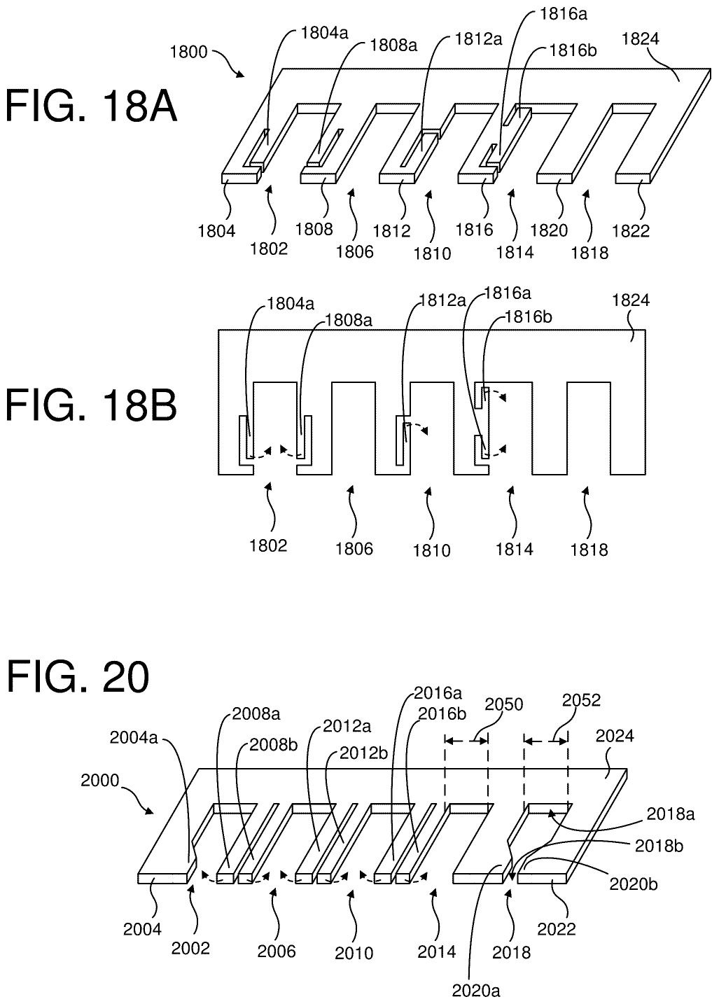

FIGS. 18A-18B are perspective and top views, respectively, depicting an eighth tool holding mechanism 1800. This exemplary embodiment 1800 is similar to the embodiment described with reference to FIGS. 17A-17F and illustrates that the bendable tabs may be implemented in a wide variety of ways. The eighth tool holding mechanism may comprise: a plate 1824 with one or more slots 1802, 1806, 1810, 1814, 1818 opening to one side of the plate 1824 (the “front” side). The slot walls are defined by segments 1804, 1808, 1812, 1816, 1820, 1822 of the plate 1824. Some (or all) of the slot-defining segments 1804, 1808, 1812, 1816, 1820, 1822 include bendable tabs 1804a, 1808a, 1812a, 1816a, 1816b that may be bent or pivoted toward the opposite slot-defining segment to reduce the effective aperture of the slot 1802, 1810, 1814. In this example: The first slot 1802 is configured with two bendable tabs 1804a, 1808a that are positioned on opposing slot-defining segments 1804, 1808 and thus work in concert to restrict the aperture of the first slot 1802. These tabs 1804a, 1808a are configured to bend in toward the back of the holder 1800 (away from the front of the holder), as depicted by the dashed curved arrows. The second slot 1806 is a standard slot without aperture-narrowing bendable tabs. The third slot 1810 is configured with a single bendable tab 1812a on one slot-defining segment 1812. This tab is configured to bend out toward the front of the holder 1800, as depicted by the dashed curved arrow. The fourth slot 1814 is configured with two bendable tabs 1816a, 1816b that are positioned on one slot-defining segment 1816 and thus work in concert to restrict the aperture of the fourth slot 1814. The first bendable tab 1816a is configured to bend in toward the back of the holder 1800 and second tab 1816b is configured to bend out toward the front of the holder 1800, as depicted by the dashed curved arrows. The fifth slot 1818 is a standard slot without aperture-restricting bendable tabs.

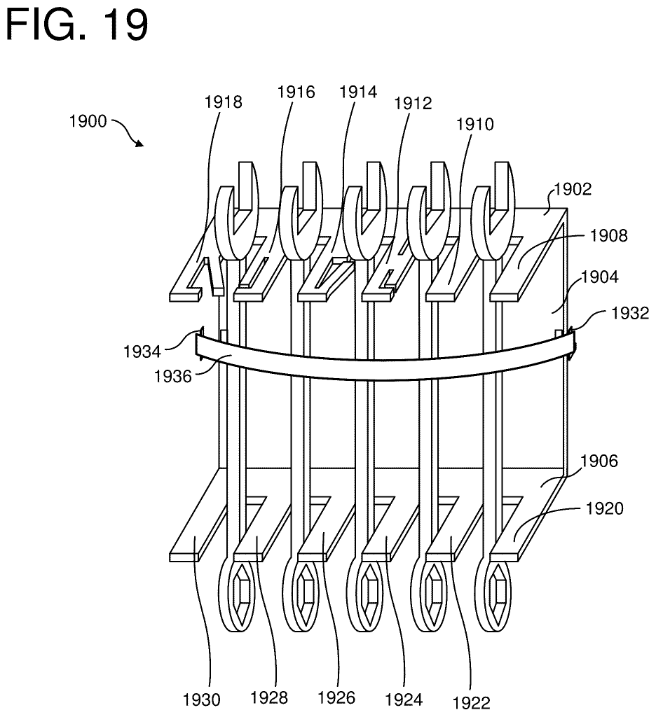

FIG. 19 depicts an exemplary tool holder 1900 configured with bendable tab features as well as some other features found in other exemplary tool holding mechanisms described herein. The tool holder 1900 includes a first plate 1902, a second plate 1906, and a third plate 1904. The first plate 1902 and second plate 1906 extend out from the third plate 1904 at or near the top and bottom edges of the third plate 1904, respectively. The first plate 1902 includes a number of segments 1908, 1910, 1912, 1914, 1916, 1918 that extend toward the front edge of the first plate 1902, defining tool-holding slots therebetween. The second plate 1906 includes a number of segments 1920, 1922, 1924, 1926, 1928, 1938 that extend toward the front edge of the second plate 1906, defining tool-holding slots therebetween which correspond to the tool holding slots of the first plate. As depicted, the first and second plate 1902, 1906 extend out at roughly 90 degrees from the third plate, but may extend out at other angles, so long as the slots in the first and second plate 1902, 1906 are open to the front of the holder 1900 to accept tools. For example, the first plate 1902 may be sloped up away from the third plate 1904 (greater than 90 degrees) and the second plate 1906 may be sloped down away from the third plate 1904 (also greater than 90 degrees). Or both the first and second plates 1902, 1906 may be sloped up or both down. In this example, some, but not all, of the forward-projecting segments 1908, 1910, 1912, 1914, 1916, 1918 on the first plate are configured with bendable tabs as described above. The tool holder 1900 also includes band retention hooks 1932, 1934 mounted to the third plate and configured to receive an elastic retention band 1936. As described above, the band 1936 (e.g., a rubber band, metal strip, or coil spring) is configured to provide a backward-directed force on tools within the holder when the band is strained over the tools and connected to the band-retention hooks 1932, 1934. In the illustrated configuration: The bendable tabs of the top plate 1902 may be positioned to help retain tools in the tool slots, customized on a tool-by-tool basis. The retention band 1936 may be placed over tools in the tool slots to help retain the tools in the slots. The tool holder 1900 may alternatively include an upwardly sloped first plate 1902 to help retain the tools in the tool slots. The tool holder 1900 may include a magnet placed between the first and second plates 1902, 1906 to help retain the tools in the slots. And some or all of the forward-projecting segments 1920, 1922, 1924, 1926, 1928, 1938 of the second plate may be configured with bendable tabs to help retain tools in the tool slots.

FIG. 20 depicts an exemplary tool holder 2000 configured with means for narrowing a tool-holding slot to help retain the tool in the slot. The holder 2000 has a plate 2024 with a number of slots 2002, 2006, 2020, 2014, 2018 therein. The slots are open to a first edge of the plate 2024 (the “front” edge). Each slot has a characteristic width 2050, 2052 near its back edge (the edge opposite the front opening toward the “back” edge of the plate). The slots may each have a unique characteristic width, or two or more or all slots may have the same characteristic width. “Lip” features may be positioned on the plate 2024 to narrow this characteristic width for slot areas forward of the back edge. For instance, one or more lips comprising a protrusion 2004a, 2020a, 2020b may be positioned on the plate 2024 adjacent to a slot 2002, 2018 to narrow the slot aperture to help restrain a tool within from inadvertent escape through the slot's forward opening and/or to provide surfaces to engage tool surfaces to keep the tool from passing down through the slot and to thereby vertically support the tool being held. The slot 2002, 2006, 2020, 2014 may also, or instead, be narrowed with a lip comprising a bendable tab 2008a, 2008b, 2012a, 2012b, 2016a, 2016b. As described above, the tab 2008a, 2008b, 2012a, 2012b, 2016a may be selectively bent to narrow the slot. The lip may be positioned so as to narrow the slot at the front opening 2018b of the slot or it may be positioned away from the front opening 2018a toward the back edge 2018b of the slot.

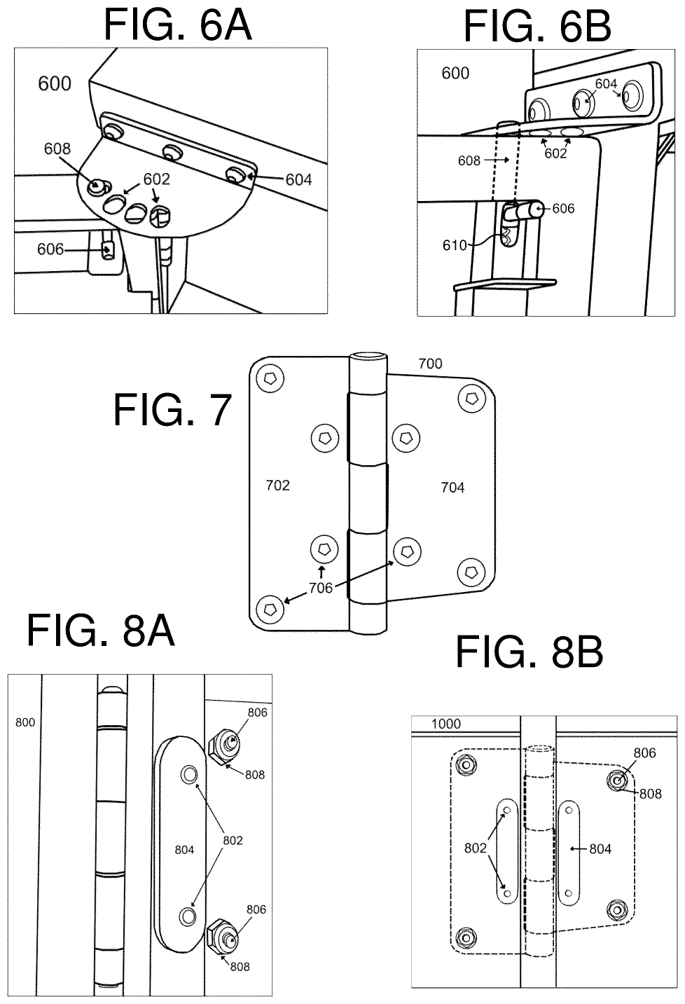

FIGS. 6A-6B depict an exemplary door stop mechanism 600. FIG. 6A is a top perspective view, FIG. 6B is a side perspective view. In one embodiment, the door stop mechanism 600 may comprise a plurality of holes 602 configured to secure a door of a tool box at a plurality of open angles. In one embodiment, at least one of the plurality of holes 602 may correspond with a closed position of the door. The door may comprise a stop 608 configured to protrude outward from a top side surface of the door and through at least one of the plurality of holes of the door stop mechanism. The door stop mechanism 600 may be configured to secure the door at the plurality of open angles by receiving the stop 608 in one of the plurality of holes 602. In one embodiment, the stop 608 may be configured to be controlled by a stop handle 606 disposed internal to the door. The stop 608 may be biased to engage the holes 602 using a spring 610. The biasing force of the spring 610 may be manually overridden using the stop handle 606 to remove the stop 608 from a hole 602 and thereby enable the door to move further open or closed.

FIG. 7 depicts a front view of a hinge 700. In one embodiment, the hinge 700 may be the hinge featured in a hinge locking system 800 of FIG. 1. The hinge 700 may comprise a first side 702 coupled to a tool box and a second side 704 coupled to a door of the tool box. The first side 702 and second side 704 may be coupled to the tool box and door, respectively, using a plurality of screws 706.

FIG. 8A-8B are back views depicting an exemplary hinge locking system 800 from a back view (with a hinge depicted in dashed line in FIG. 8B). The hinge locking system 800 may comprise at least one first screw 802 captured by a secured surface 804 and at least one second screw 806 captured by a lock nut 808. The secured surface 804 may be integral or attached to the door or tool box. The hinge locking system 800 enables a user installing a door to a tool box using screws or bolts in such a way that the user can adjust the door's hinges while the door is closed. The hinges can be preliminarily installed to the door/frame using first hinge screws (or similar threaded fasteners) 802 and secured surfaces 804 (e.g., an elongate plate with two threaded holes to accept the screws 802). The hinge is on the front side of the door/frame (the side facing away from the tool box when the door is closed), the secured surfaces 804 are on the back side of the door/frame (the side facing into the tool box when the door is closed). The first hinge screws 802 are disposed through mounting holes in the hinge and the door/frame and then into threaded holes in the secured surfaces 804. The secured surfaces 804, now preliminarily held in place by the first hinge screws 802, resist rotation when the first screws 802 are tightened thereby enabling the first screws 802 to be tightened with the door in the closed position. Thus, the door and frame may be finely aligned while the door is in the closed position and then the first hinge screws 802 may be tightened into the secured surfaces 804 to hold the door and frame in alignment. Once the door and frame are held in proper alignment, the door may be opened to install locking screws 806 (or similar threaded fasteners) that prevent removal of the hinge when the door is in the closed position. For example, second hinge screws 806 may be bolts disposed through mounting holes in the hinge and door/frame and secured in place using lock nuts 808 on the back side of door/frame. To remove the bolts 806, the door must first be opened to access the lock nuts 808. If the closed door is locked against opening, the hinges cannot be removed simply by removing all the screws 802, 806. The door lock can not be simply defeated by removing the hinges by removing the hinge screws 802, 806. Thus, a user can preliminarily install door to frame, close the door, adjust the door's fit iteratively until the door is properly fitted to the frame, tighten the first screws 802 to hold the door and frame in proper alignment, then use irremovable screws or locknuts to secure the door to the frame while the door is in an open position. This allows the door to be secure when it is closed as the hinges cannot be removed from the outside by removing the hinge screws 802, 806.

FIG. 9 is a perspective view of an exemplary portable tool holding system 900. The portable system 900 may comprise a mounting plate 902 and a plurality of tool holding mechanisms 904 coupled to a surface of the mounting plate 902. The mounting plate 902 may be configured with keyhole-style mounting holes 908 so as to be selectively slide-mountable to studs (e.g., screw-heads or bolt-heads) protruding from a surface (such as a wall in a house or shed or a surface of a tool box or work bench). The mounting plate 902 may be configured with an over-the-door hanging hook 910 so as to be selectively mountable to a door or similar slab. The portable tool holding system 900 may also be configured with a handle 906 for ease of transport. In one embodiment, the plurality of tool holding mechanisms 904 may comprise at least one of the first tool holding mechanism 200 of FIG. 2, the second tool holding mechanism 300 of FIG. 3, the third tool holding mechanism 400 of FIG. 4, the fourth tool holding mechanism 500 of FIG. 5, the fifth tool holding mechanism 1500 of FIGS. 15A-15B, the sixth tool holding mechanism 1600 of FIGS. 16A-16B, the seventh tool holding mechanism 1700 of FIGS. 17A-17F, or the eighth tool holding mechanism 1800 of FIGS. 18A-18B.

Returning to FIG. 1, the tool box 100 may comprise a back wall 103 and doors 104 and a plurality of tool holding mechanism variants 102 coupled to the wall 103 and doors 104. In one embodiment, the tool holding mechanism variants 102 may comprise at least one of the first tool holding mechanism 200 of FIG. 2, the second tool holding mechanism 300 of FIG. 3, the third tool holding mechanism 400 of FIG. 4, the fourth tool holding mechanism 500 of FIG. 5, the fifth tool holding mechanism 1500 of FIGS. 15A-15B, the sixth tool holding mechanism 1600 of FIGS. 16A-16B, the seventh tool holding mechanism 1700 of FIGS. 17A-17F, or the eighth tool holding mechanism 1800 of FIGS. 18A-18B. The tool box 100 may also include the door stop mechanism 600 and hinge locking systems 800 described herein.

While the foregoing description is directed to the preferred embodiments of the invention, other and further embodiments of the invention will be apparent to those skilled in the art and may be made without departing from the basic scope of the invention. And features described with reference to one embodiment may be combined with other embodiments, even if not explicitly stated above, without departing from the scope of the invention. The scope of the invention is defined by the claims which follow.

The invention claimed is:

1. A tool holding mechanism comprising:
(a) a first plate comprising a front edge, a first segment extending toward the front edge, and a second segment extending toward the front edge and positioned relative to the first segment to define a first slot therebetween;
(b) a first bendable tab connected to the first segment;
(c) wherein the first slot is open to the front edge and has a first width spanning the distance between the first segment and the second segment; and
(d) wherein the first bendable tab is configured to bend toward the second segment.

2. The tool holding mechanism of claim 1 further comprising a second bendable tab connected to the first segment, wherein the second bendable tab is configured to bend toward the second segment.

3. The tool holding mechanism of claim 1 further comprising a second bendable tab connected to the second segment, wherein the second bendable tab is configured to bend toward the first segment.

4. The tool holding mechanism of claim 1 wherein the first plate further comprises a third segment extending toward the front edge and positioned relative to the second segment to define a second slot therebetween.

5. The tool holding mechanism of claim 4 further comprising a second bendable tab connected to at least one of the group consisting of the first segment, the second segment, and the third segment.

6. The tool holding mechanism of claim 1 further comprising:
(a) a second plate comprising a second front edge, a third segment extending toward the second front edge, and a fourth segment extending toward the second front edge and positioned relative to the third segment to define a second slot therebetween;
(b) a third plate comprising a top edge and a bottom edge;
(c) wherein the second plate extends from the third plate at the bottom edge;
(d) wherein the first plate extends from the third plate at the top edge.

7. The tool holding mechanism of claim 6 further comprising a magnet positioned between the first plate and the second plate.

8. The tool holding mechanism of claim 6 further comprising a first retention hook and a second retention hook, wherein the first retention hook and the second retention hook are each configured to receive an elastic retention band.

9. The tool holding mechanism of claim 8 further comprising at least one elastic retention band wherein the at least one elastic retention band is connected to the first retention hook and the second retention hook and configured to be strained over a tool positioned in the first slot and second slot to thereby apply a force on the tool toward the third plate.

10. The tool holding mechanism of claim 8 wherein the elastic retention band is one of the group consisting of a rubber band, a coil spring, and a metal strip.

11. The tool holding mechanism of claim 6 wherein the angle between the first plate and the third plate is greater than 90 degrees.

12. The tool holding mechanism of claim 6 wherein the angle between the second plate and the third plate is greater than 90 degrees.

13. A tool holder comprising:
(a) a first plate having a first back edge and first front edge and configured with a first slot that is open at the first front edge and configured to receive a tool; and
(b) a lip positioned to narrow the first slot, the lip including at least one of the group consisting of a bendable tab and a protrusion.

14. A tool holder of claim 13 further comprising a second plate having a second back edge and a second front edge and configured with a second slot that is open at the second front edge wherein the second slot opening is aligned with the first slot opening.

15. The tool holder of claim 14 wherein the first and second plates are substantially parallel.

16. The tool holder of claim 14 wherein the first plate is positioned to the second plate so that a distance between the first back edge and the second back edge is less than a distance between the first front edge and the second front edge.

17. The tool holder of claim 14 wherein the first plate is positioned to the second plate so that a first distance between the first back edge and the second back edge is different from a second distance between the first back edge and the second back edge.

18. The tool holder of claim 13 wherein the lip is positioned adjacent to the first slot at the first front edge to narrow the first slot at the first front edge.

19. The tool holder of claim 13 wherein the lip is positioned adjacent to the slot at a point between the first front edge and the first back edge to narrow the first slot at a point between the first front edge and the first back edge.

20. The tool holder of claim 13 wherein the lip is selectively positionable to enable selective narrowing of the slot.

21. The tool holder of claim 14 wherein the second slot is narrower than the first slot.

22. The tool holder of claim 14 further comprising a retaining segment projecting out from the second plate toward the first plate and positioned adjacent to the second slot.
